(19) United States
(12) Patent Application Publication
(10) Pub. No.: US 2016/0074807 A1
(43) Pub. Date: Mar. 17, 2016

(54) Method of Sequestering Carbon Dioxide

(71) Applicant: GULF ORGANISATION FOR RESEARCH AND DEVELOPMENT, Doha (QA)

(72) Inventors: Mohammed S. Imbabi, Aberdeen, Aberdeenshire (GB); Frederik P. Glasser, Aberdeen, Aberdeenshire (GB); Jose Luiz Galvez Martos, Aberdeen, Aberdeenshire (GB); Guillaume Jauffret, Aberdeen, Aberdeenshire (GB); Jennie Morrison, Aberdeen, Aberdeenshire (GB)

(21) Appl. No.: 14/888,179

(22) PCT Filed: Apr. 30, 2014
(86) PCT No.: PCT/GB2014/051330

§ 371 Date: Oct. 30, 2015

(30) Foreign Application Priority Data
Apr. 30, 2013 (GB) 1307830.8

(51) Int. Cl. B01D 53/62

(52) U.S. Cl. CPC B01D 53/62; B01D 2251/402; B01D 2258/0233

(57) ABSTRACT

A method of sequestering carbon dioxide comprises reacting the carbon dioxide with aqueous magnesium ions at elevated pH to form magnesium carbonate-containing salts. The carbon dioxide is preferably reacted with alkali to form carbonate and/or bicarbonate anions at elevated pH, and the carbonate and/or bicarbonate anions are subsequently reacted with aqueous magnesium cations to form the magnesium carbonate-containing salts. A preferred alkaline material for use in elevating the pH of the aqueous solution in the present invention is Cement Kiln Dust (CKD), and a preferred source of aqueous magnesium ions is reject water from a desalination plant.

The present invention relates to a method of sequestering carbon dioxide.

The combustion of hydrocarbons produces carbon dioxide at unacceptable levels, as evidenced by the rising carbon dioxide content of the atmosphere and its claimed impacts on climate.

Many efforts have been made to prevent or reduce the accumulation of carbon dioxide, but these are either too expensive or are of uncertain effectiveness in the long term, or both.

Carbon capture and storage are examples; physical separation of carbon dioxide from nitrogen, which comprises 80% of the normal atmosphere, is expensive, and geological sequestration of carbon dioxide, which remains partly in liquid form, is of uncertain effectiveness and safety. This process utilises solvent stripping for carbon dioxide and thus potentially gives rise to secondary waste streams. Biological conversion to biomass, via photosynthesis, remains a possibility, but may not yield useful products or achieve permanent sequestration.

Present processes centre around carbon dioxide capture and sequestration. Presently available processes require (i) a gas treatment step, stripping carbon dioxide from the much more abundant nitrogen and water vapour in outlet gases from, for example, a coal-fired power plant and (ii) liquefaction of the carbon dioxide followed by its sequestration in underground storage, perhaps in disused oil or gas horizons. This however requires considerable investment in plant and process equipment and, of course, the success of permanent sequestration depends on a number of factors which are not readily assessed, including the integrity of the reservoir and its seals, as well as the absence of disruptive events.

The present invention seeks to provide an improved method for sequestering carbon dioxide.

According to the present invention there is thus provided a method for sequestering carbon dioxide which comprises reacting the carbon dioxide with aqueous magnesium ions at elevated pH to form magnesium carbonate-containing salts.

A preferred method of the present invention comprises reacting the carbon dioxide with alkali to form carbonate and/or bicarbonate anions at elevated pH, and subsequently reacting the carbonate and/or bicarbonate anions with aqueous magnesium cations to form magnesium carbonate-containing salts. This two-stage reaction has advantages over a one-stage reaction (i.e. reacting the carbon dioxide with alkali and aqueous magnesium cations together) in that the amount of alkali to be used can be optimised, since an excess of alkali might increase alkalinity to a level restricting or preventing disposal, and the carbon dioxide sequestration and precipitation steps can be differentiated and separately controlled, resulting in a more efficient use of alkali and temperature monitoring and control.

The carbon dioxide, or carbonate and/or bicarbonate containing aqueous solution is reacted with the aqueous magnesium ions at elevated pH, for example 8 to 12, preferably 10 to 12, or 9 to 11. The pH of the aqueous solution may be elevated either before or during reaction of the aqueous magnesium ions with the carbon dioxide, but as noted above is preferably elevated before reaction of the aqueous magnesium ions with the carbon dioxide. The elevation of pH (i) increases the solubility of carbon dioxide in water, (ii) enhances the saturation rate of brine with respect to carbon dioxide—hydroxide acts as a catalyst—and (iii) precipitates magnesium, whose solubility reduces at high pH, with concomitant precipitation of magnesium salts containing carbonate.

The carbon dioxide is preferably reacted with alkali at an elevated concentration of alkali, for example 1 to 3 equivalent moles of alkali per litre, preferably 1.5 to 2. A mixture of carbonates and bicarbonates forms according to the following reactions:

CO₂(g)+2OH⁻(aq)→CO₃²⁻(aq)+H₂O(l) [1]

CO₂(g)+CO₃²⁻(aq)+H₂O(l)→2HCO₃⁻(aq) [2]

According to reactions [1] and [2], the equivalent moles of alkali per mole of sequestered carbon dioxide would be between 1 and 2, preferably 1.5 to 2.

The carbonate and/or bicarbonate containing aqueous solution resulting from the reaction of the carbon dioxide with alkali preferably reacts with the magnesium ions precipitating magnesium carbonate-containing salts at a temperature of 10 to 80° C., preferably 20 to 70° C.

In practice, it is preferable to provide a large interfacial area to increase the rate of gas-liquid reaction between carbon dioxide and alkali, for example by utilising a packed bed column. However, alternatives such as spray contactors or, if absorption kinetics are slow, plate towers may be used if high concentrations of carbonate in solution risk blocking the packed bed. Previous studies of carbon dioxide absorption in aqueous sodium hydroxide (Tepe and Dodge, 1943) performed using a packed column indicate that gas flow has a negligible effect on the reaction, while the absorption rate is proportional to LO.28 (where L is the liquid rate), and that the overall gas-phase transfer coefficient depends on the sodium hydroxide concentration. Other studies (Sahay and Sharma 1973) have shown that the transfer coefficient of carbon dioxide in alkaline solutions depends upon the partial pressure of carbon dioxide.

The pH of the aqueous solution may be raised using any suitable alkaline material, such as hydroxides. For example, sodium hydroxide may be used for this purpose. Ammonia may also be used because it can in principle be recovered and recycled.

A preferred alkaline material for use in elevating the pH of the aqueous solution in the present invention is Cement Kiln Dust (CKD). CKD is a waste material which is normally collected and disposed of in landfill. CKD will typically be used as a supplementary source of alkali along with other alkaline materials, such as sodium hydroxide.

The operation of a cement plant requires that the effluent gas is treated by electrostatic precipitation to remove mineral dusts prior to discharge. The dust is enriched in alkali, mainly in the form of sulfate and in free lime, CaO. Upon contact with water, sulfate is partly precipitated as calcium sulfate while the alkali is effectively and spontaneously converted to sodium and potassium hydroxide. Thus, the reaction of CKD with water provides hydroxide ions.

CKD mainly comprises particulate matter from the kilns of the cement plant and mineralogically typically consists of free CaO (lime) as well as calcite, calcium sulphate and calcium silicate, the latter mainly as dicalcium silicate. However, the actual chemical/mineral components making up CKD will be characteristic of and vary from plant to plant.

A condensate may be added to the CKD from the kiln gas phase. This adds potassium chloride and other volatiles to the dust. In this way, the dust may contain two classes of potentially soluble salts: (i) condensate salts such as KCl and (ii) free lime together with calcium silicate. The former class dissolves rapidly in water giving a high pH solution but with limited potential to buffer a high pH, while the latter have a high pH as well as better buffering capacity but with the potential disadvantage that they leave behind a solid residue.

Any suitable source of aqueous magnesium ions may be used in the method of the present invention. For example, seawater contains approximately 1.2 g/L of magnesium. However, a preferred source of aqueous magnesium ions is reject water from a desalination plant, on account of its enrichment in magnesium, approximately 2-5 g/L. The reduction in water volume resulting from the use of desalination plant effluent can provide economic benefits over using a less enriched magnesium ion source, such as seawater.

A further advantage in the use of reject water from desalination plants in the present invention is that the water which is returned to the sea after having been used in the method will contain fewer magnesium salts and be less alkaline than before, and is thus environmentally less harmful.

The method of the present invention is thus particularly suitable for sequestering carbon dioxide produced by a cement plant, since CKD produced by the plant can be used as a cheap source of alkali to elevate pH and sequester carbon dioxide as aqueous carbonate and/or bicarbonate. Furthermore, by coupling a cement plant with a desalination plant, magnesium-enriched water discharges from desalination can be used as the aqueous magnesium ion source.

The method of the present invention reacts carbon dioxide with aqueous magnesium ions at elevated pH to form magnesium carbonate-containing salts, and preferably reacts carbon dioxide with alkali at elevated pH to form carbonates and/or bicarbonates, which are subsequently reacted with aqueous magnesium ions, precipitating magnesium salts containing carbonate, preferably at a temperature of 10 to 80° C., more preferably 20 to 70° C. The magnesium ions may for example be present in brine or reject water from a desalination plant. Examples of salts which may be formed by the method of the present invention include salts of the nesquehonite-lansfordite family, MgCO₃.nH₂O, the hydromagnesite-dypingite family, Mg₅(CO₃)₄(OH)₂.nH₂O, and the artinite family, Mg₂(CO₃)(OH)₂.3H₂O. A table of different phases which may be formed from these reactions is given below in Table 1:

TABLE 1

| | | Mass (%) | | |
|---|---|---|---|---|
| Mineral name | Chemical formula | MgO | CO₂ | H₂O |
| Lansfordite | MgCO₃•5H₂O | 23.1 | 25.2 | 51.7 |
| (LF) | | | | |
| Nesquehonite | MgCO₃•3H₂O | 29.1 | 31.8 | 39.1 |
| (NQ) | | | | |
| Artinite | Mg₂CO₂(OH)₂•3H₂O | 41.0 | 22.4 | 36.6 |
| (AN) | | | | |
| Dypingite | 4MgCO₃•Mg(OH)₂•5H₂O | 41.5 | 36.2 | 22.3 |
| (DG) | | | | |
| Hydromagnesite | 4MgCO₃•Mg(OH)₂•4H₂O | 43.1 | 37.6 | 19.3 |
| (HM) | | | | |

The favoured formation of each of these phases will depend upon the reaction conditions, including temperature, carbon dioxide partial pressure and/or alkali concentration. For example, studies show that the most likely phase to be produced at room temperature is NQ, which appears to slowly convert to HM at room temperature over a period of months or years. The results of a synthesis study in this regard are described below in the Example.

The magnesium carbonate-containing salts formed by the method of the present invention may be useful in making construction materials.

### EXAMPLE

### Synthesis Study

Experiments were performed to study the effect of varying the temperature and reaction time on the phase of product formed from the reactions of the method of the present invention, including the yields of magnesium and consequently carbon dioxide in the product.

Thus, 100 ml of a 1M MgCl₂ solution was added to 1 L of a 0.1M Na₂CO₃ solution brought to the target temperature. After filtration, the solid was dried over silica gel, ground, and scanned by XRD and SEM.

The yield of the reaction for Mg was calculated from the relation: Mg yield [mass %]=100*(mass of Mg in initial solution−mass of Mg in filtrate)/mass of Mg in initial solution. The mass of Mg in the filtrate was calculated from AAS measurements: the lower the Mg concentration in the filtrate, the higher the yield and so the higher the amount of Mg being precipitated. The uncertainty of the yield values is +/−5% due to uncertainties in amounts recovered and in analyses. For example, variations in the total volume as well as the amount of water incorporated in the solid products have been neglected: for 0.1 mol of NQ precipitated, the volume of water incorporated is the order of 5 mL, whereas for 0.02 mol of HM precipitated, the volume of water incorporated is the order of 2 mL (results for an initial total volume of approximately 1.1 L).

The yield of the reaction for CO₂ can be calculated from the Mg yield as such: CO₂ yield [mass %]=Mg yield*R where R is the CO₂/Mg molar ratio in the product formed (R=1 for NQ and R=0.8 for HM/DG/DG*), see Table 1 above. (N.B. “DG*” is short-hand notation for a dypingite-like phase, i.e. a phase similar to hydromagnesite but with more than 4 moles of crystallisation water per formula unit, DG being the specific case where there are 5 moles of crystallisation water). As HM, DG and DG* have the same R value, there is no need to define the relative amounts of each phase in the case of a mixture. However, in the case of a mixture of NQ and HM/DG/DG*, the two R values are different and so the relative proportions of the phases need to be estimated from the XRD patterns. Because of the approximation made, a range of values instead of a single value is given in Table 2. The uncertainty of each value is +/−5%.

TABLE 2

| | | Main phase in | Mg yield | CO₂ yield |
|---|---|---|---|---|
| T (° C.) | t (h) | product | (mass %) | (mass %) |
| 25 | 1 | NQ | 59 | 59 |
| | 2 | NQ | 82 | 82 |
| | 4 | NQ | 91 | 91 |
| | 24 | NQ | 86 | 86 |
| 35 | 1 | NQ | 68 | 68 |
| | 2 | NQ | 77 | 77 |
| | 4 | NQ + DG* | 77 | 76-77 |
| | 24 | DG* (2 phases) | 73 | 58 |
| 45 | 1 | NQ + DG* | 77 | 76-77 |
| | 2 | NQ + DG* | 82 | 81-82 |
| | 4 | NQ + DG* | 82 | 75-78 |
| | 24 | DG* | 86 | 69 |
| 55 | 1 | NQ + DG* | 77 | 76-77 |
| | 2 | DG* | 73 | 58 |
| | 4 | DG* | 82 | 66 |
| | 24 | HM + DG* | 82 | 66 |
| 65 | 1 | HM + DG | 86 | 69 |
| | 2 | HM + DG | 86 | 69 |
| | 4 | HM + DG* | 86 | 69 |
| | 24 | HM | 95 | 76 |

1. A method of sequestering carbon dioxide which comprises reacting the carbon dioxide with aqueous magnesium ions at elevated pH to form magnesium carbonate-containing salts.

2. A method according to claim 1 wherein the carbon dioxide is reacted with alkali to form carbonate and/or bicarbonate anions at elevated pH, and the carbonate and/or bicarbonate anions are subsequently reacted with aqueous magnesium cations to form the magnesium carbonate-containing salts.

3. A method according to claim 1 wherein the carbon dioxide is reacted with the aqueous magnesium ions at a pH of 8 to 12.

4. A method according to claim 2 wherein the carbon dioxide is reacted with the alkali at 1 to 3 equivalent moles of alkali per litre.

5. A method according to claim 2 wherein the equivalent moles of alkali per mole of sequestered carbon dioxide is between 1 and 2.

6. A method according to claim 2 wherein the carbonate and/or bicarbonate containing aqueous solution resulting from the reaction of the carbon dioxide with alkali reacts with the magnesium ions precipitating magnesium carbonate-containing salts at a temperature of 10 to 80° C.

7. A method according to claim 1 wherein the alkaline material used to elevate the pH of the aqueous solution comprises Cement Kiln Dust (CKD).

8. A method according to claim 7 wherein a condensate is added to the CKD from the kiln gas phase.

9. A method according to claim 1 wherein the source of aqueous magnesium ions is reject water from a desalination plant.

10. A method according to claim 1 wherein the magnesium ions are present in the aqueous solution in an amount of 2-5 g/L.

11. A method according to claim 1 for sequestering carbon dioxide produced by a cement plant.

12. A method according to claim 11 wherein the cement plant is coupled with a desalination plant.

13. A method according to claim 1 wherein the magnesium carbonate-containing salts formed by the method include salts of the nesquehonite-lansfordite family, Mg(CO₃).nH₂O, the hydromagnesite-dypingite family, Mg₅(CO₃)₄(OH)₂.nH₂O, and/or the artinite family, Mg₂(CO₃)(OH)₂.3H₂O.
